(19) United States
(12) Patent Application Publication
(10) Pub. No.: US 2025/0102682 A1
(43) Pub. Date: Mar. 27, 2025

(54) MOVEMENT TRAJECTORY GENERATION METHOD, ELECTRONIC DEVICE, AND READABLE STORAGE MEDIUM

(71) Applicant: GUANGDONG COROS SPORTS TECHNOLOGY CO., LTD, Dongguan (CN)

(72) Inventor: Yu TANG, Dongguan (CN)

(21) Appl. No.: 18/787,383

(22) Filed: Jul. 29, 2024

(30) Foreign Application Priority Data
Sep. 22, 2023 (CN) 202311238427.0

(51) Int. Cl. G01S 19/07; H04W 4/029

(52) U.S. Cl. CPC G01S 19/07; H04W 4/029

(57) ABSTRACT

A movement trajectory generation method includes obtaining first positioning information, obtaining attitude information of a movable platform, generating a movement trajectory of the movable platform according to the first positioning information and the attitude information of the movable platform, obtaining second positioning information, and correcting the movement trajectory according to the second positioning information.

### CROSS-REFERENCE TO RELATED APPLICATION

This application claims priority to Chinese Patent Application No. 202311238427.0, filed on Sep. 22, 2023, the entire content of which is incorporated herein by reference.

### TECHNICAL FIELD

The present disclosure generally relates to the field of computer technologies and, more particularly, to a movement trajectory generation method, an electronic device and a readable storage medium.

### BACKGROUND

Satellite positioning systems can provide accurate and real-time positioning data, and are often used to monitor a user's movement trajectory during cycling, running, etc. Specifically, in actual applications, to obtain an accurate movement trajectory, a positioning assembly of an electronic device carried by the user will determine the position of the electronic device by continuously receiving the global positioning system (GPS) signal transmitted by satellites, to generate a movement trajectory of the electronic device, i.e., a movement trajectory of the user, based on the multiple positions received.

However, the movement trajectory generated by the existing electronic device is not accurate. For example, when the electronic device passes through an area where the GPS signal cannot be received or the GPS signal is weak, the electronic device cannot obtain the accurate position, resulting in an inability to generate an accurate movement trajectory.

### SUMMARY

In accordance with the disclosure, there is provided a movement trajectory generation method including obtaining first positioning information, obtaining attitude information of a movable platform, generating a movement trajectory of the movable platform according to the first positioning information and the attitude information of the movable platform, obtaining second positioning information, and correcting the movement trajectory according to the second positioning information.

Also in accordance with the present disclosure, there is provided an electronic device including at least one memory storing at least one computer program, and at least one processor configured to execute the at least one computer program to obtain first positioning information, obtain attitude information of a movable platform, generate a movement trajectory of the movable platform according to the first positioning information and the attitude information of the movable platform, obtain second positioning information, and correct the movement trajectory according to the second positioning information.

Also in accordance with the present disclosure, there is provided a non-transitory computer-readable storage medium store at least one computer program that, when executed by at least one processor, causes the at least one processor to obtain first positioning information, obtain attitude information of a movable platform, generate a movement trajectory of the movable platform according to the first positioning information and the attitude information of the movable platform, obtain second positioning information, and correct the movement trajectory according to the second positioning information.

### BRIEF DESCRIPTION OF THE DRAWINGS

FIG. 1 is a flow chart of a movement trajectory generation method consistent with the present disclosure.

FIG. 2 to FIG. 5 are schematic diagrams showing scenarios corresponding to a movement trajectory generation method consistent with the present disclosure.

FIG. 6 is a schematic structural diagram of a movement trajectory generation device consistent with the present disclosure.

FIG. 7 is a schematic structural diagram of an electronic device consistent with the present disclosure.

### DETAILED DESCRIPTION OF THE EMBODIMENTS

Specific embodiments of the present disclosure are hereinafter described with reference to the accompanying drawings. The described embodiments are merely examples of the present disclosure and do not limit the scope of the present disclosure, which may be implemented in various ways. Specific structural and functional details described herein are not intended to limit, but merely serve as a basis for the claims and a representative basis for teaching one skilled in the art to variously employ the present disclosure in substantially any suitable detailed structure. The present disclosure may also be implemented in other embodiments without these specific details. In other cases, detailed descriptions of well-known systems, devices, circuits, and methods are omitted so as not to obscure the description of the present disclosure with unnecessary details.

When used in the specification and the claims in the present disclosure, the term “including” indicates the presence of the described features, wholes, steps, operations, elements and/or components, but does not exclude the presence or addition of one or more other features, wholes, steps, operations, elements, components and/or their collections.

The term “and/or” used in the specification and the claims in the present disclosure refers to any combination of one or more of the items listed in association and all possible combinations, and includes these combinations.

As used in the specification and the claims in the present disclosure, the term “if” can be interpreted as “when . . . ” or “once” or “in response to determination” or “in response to detection” according to the context. Similarly, the phrase “if it is determined” or “if [the described condition or event] is detected” can be interpreted as meaning “once it is determined” or “in response to determination” or “once [the described condition or event] is detected” or “in response to detection of [the described condition or event]” according to the context.

In addition, in the specification and the claims in the present disclosure, the terms “first,” “second,” “third,” etc. are only used to distinguish the description, and cannot be understood as indicating or implying relative importance.

References to “one embodiment” or “some embodiments” etc. described in the specification of the present disclosure mean that one or more embodiments of the present disclosure include specific features, structures or characteristics described in conjunction with the embodiments. Therefore, the statements “in one embodiment,” “in some embodiments,” “in some other embodiments,” etc., that appear in different places in this specification do not necessarily refer to the same embodiment, but mean “one or more but not all embodiments,” unless otherwise specifically emphasized in other ways. The terms “including,” “comprising,” “having” and their variations all mean “including but not limited to,” unless otherwise specifically emphasized in other ways. “Multiple” or “plurality of” means “two or more.”

Satellite positioning systems can provide accurate and real-time positioning data, and are often used to monitor a user's movement trajectory during cycling, running, etc. Specifically, in actual applications, to obtain an accurate movement trajectory, a positioning assembly of an electronic device carried by the user will determine positions of the electronic device by continuously receiving the global positioning system (GPS) signal transmitted by satellites, to generate the movement trajectory of the electronic device, i.e., the movement trajectory of the user, based on the multiple positions received.

However, the movement trajectory generated by existing electronic devices is not accurate. For example, when the electronic device passes through an area where the GPS signal cannot be received or the GPS signal is weak, the electronic device cannot obtain the accurate position, resulting in an inability to generate an accurate movement trajectory. Therefore, how to effectively generate an accurate movement trajectory is a problem to be solved.

The present disclosure provides a movement trajectory generation method, an electronic device and a readable storage medium, to at least partially solve the above problem. In the movement trajectory generation method provided by the present disclosure, a first movement trajectory may be generated using attitude information of a movable platform and the first positioning information, and then the first movement trajectory may be corrected using obtained second positioning information, to obtain a corrected first movement trajectory. Since both the first positioning information and the second positioning information are accurate positioning information directly obtained, the first movement trajectory may be corrected using the second positioning information, such that the corrected first movement trajectory may be more accurate, therefore partially solving the problem that the movement trajectory generated by an existing electronic device is not accurate.

The movement trajectory generation method provided by various embodiments of the present disclosure may be applied to a mobile terminal. The mobile terminal may be a bike computer, a mobile phone, a tablet computer, a wearable device, an augmented reality (AR)/virtual reality (VR) device, a laptop computer, an ultra-mobile personal computer (UMPC), a netbook, a personal digital assistant (PDA), a vehicle-mounted device, a smart screen, etc. The present disclosure has no limit on the specific type of the mobile terminal.

The mobile terminal may be provided at a movable platform to generate an accurate movement trajectory for the movable platform using the movement trajectory generation method provided by various embodiments of the present disclosure. The movable platform may include, but is not limited to, a movable object such as a person, a bicycle, an electric vehicle, a car, a robot, etc.

For example, in one embodiment, when the terminal device is a mobile phone or a wearable device, the terminal device may be worn on a human body, and the movement trajectory generation method provided by various embodiments of the present disclosure may be used to generate a corresponding movement trajectory for the human body. In another embodiment, when the terminal device is a bike computer, the terminal device may be fixed at handlebars of a bicycle or an electric vehicle, and the movement trajectory generation method provided by various embodiments of the present disclosure may be used to generate a corresponding movement trajectory for the bicycle or electric vehicle.

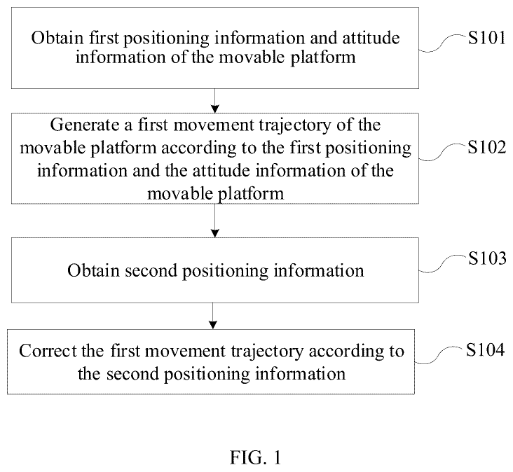

The present disclosure provides a movement trajectory generation method. As shown in FIG. 1 which is a flow chart of an example movement trajectory generation method provided by the present disclosure, in one embodiment, the movement trajectory generation method includes S101 to S104.

At S101, first positioning information and attitude information of the movable platform are obtained.

The first positioning information may be determined by a positioning assembly provided at the mobile terminal and/or the movable platform by receiving the satellite positioning signal. The satellite positioning signal may include, but is not limited to, the global navigation satellite system (GNSS) signal or the GPS signal. The first positioning information may include the longitude, latitude or other location information of the mobile terminal and/or the movable platform.

In one embodiment, the attitude information of the movable platform may be used to identify the movement trajectory of the movable platform, including information such as three-axis angle values, acceleration or geomagnetic field strength values.

In some embodiments, the above-mentioned attitude information may be obtained using an attitude sensor, a nine-axis sensor, or another device provided at the movable platform. That is, the attitude information of the movable platform may be obtained without relying on the positioning assembly of the mobile terminal and/or the movable platform.

At S102, a first movement trajectory of the movable platform is generated according to the first positioning information and the attitude information of the movable platform.

The first positioning information may be the positioning information of the terminal device, the positioning information of the movable platform, or the positioning information of the user. Therefore, the first movement trajectory of the movable platform may be generated according to the first positioning information and the attitude information of the movable platform.

In practical applications, to ensure the accuracy of the movement trajectory, the positioning assembly may usually obtain one piece of positioning information every one second, such that the first positioning information obtained may include multiple pieces of position information. Therefore, in a possible implementation, first position information of the movable platform may be determined according to the first positioning information, and the first movement trajectory of the movable platform may be generated according to the first position information and the attitude information of the movable platform. The attitude information of the movable platform may include at least one of the three-axis angle value of the movable platform or the acceleration of the movable platform.

The first position information may include the last position determined from the multiple pieces of position information of the first positioning information. Therefore, when the positioning assembly is not able to obtain the satellite signal, the first movement trajectory of the movable platform may be determined by taking the last position determined from the multiple pieces of position information as the starting point in combination with the attitude information of the movable platform. That is, the last position determined from the multiple pieces of position information may be directly determined as the starting point of the first movement trajectory, and then the first movement trajectory of the movable platform may be generated according to the starting point of the first movement trajectory and the attitude information of the movable platform.

In some other embodiments, the first position information may include a preset number of positions closest to the last position of multiple positions. The preset number may be customized. Therefore, the first movement trajectory of the movable platform may be generated according to the preset number of positions and the attitude information of the movable platform. In some embodiments, assuming that there are 5 positions determined according to the first positioning information, namely A, B, C, D, and E, the preset number may be 2, and the 2 positions closest to the last position E among the above 5 positions may be C and D. Therefore, the position C or position D may be used as the starting point of the first movement trajectory, and then the first movement trajectory of the movable platform may be generated in combination with the attitude information of the movable platform.

In some other embodiments, the first position information may also include multiple positions determined according to the first positioning information. Based on this, a second movement trajectory of the movable platform may be generated according to the multiple positions determined in the first positioning information, and then an end point of the second movement trajectory may be determined as the starting point of the first movement trajectory, and then the first movement trajectory of the movable platform may be determined according to the starting point of the first movement trajectory and the attitude information of the movable platform.

In some other embodiments, the obtained attitude information of the movable platform may also include the direction (e.g., moving direction) of the movable platform and/or the speed of the movable platform. The first movement trajectory of the movable platform may be generated according to the first positioning information, the direction of the movable platform and/or the speed of the movable platform. Further, the first position information of the movable platform may be determined according to the first positioning information, and then the first movement trajectory of the movable platform may be generated according to the first position information, the direction of the movable platform and/or the speed of the movable platform. The first position information may refer to the relevant description of the above description about the attitude information of the movable platform including the three-axis angle value of the movable platform and the acceleration of the movable platform in the aforementioned embodiments, which will not be repeated here.

In one example, the speed of the movable platform may be obtained by a speedometer fixed at the movable platform. The speedometer may be provided at the mobile terminal, and the mobile terminal may be provided at the movable platform, such that the speed of the terminal device obtained by the speedometer is the same as the speed of the movable platform. The speedometer may also be directly provided at the movable platform, and the speed of the movable platform may be directly obtained by using the speedometer. For example, assuming that the movable platform is a bicycle or a car, the speedometer may be provided at a wheel hub of the bicycle or the car. In this way, when the radius or diameter of the bicycle or car wheel is constant, the speed of the bicycle or the car may be determined by obtaining the rotational angular velocity of the bicycle or car wheel or the number of turns of the wheel.

When the speedometer is directly provided at the movable platform, the speedometer may be directly connected to the mobile terminal for communication, such that the mobile terminal is able to directly obtain the speed of the movable platform (i.e., the mobile terminal); or the movable platform may be connected to the mobile terminal through communication, and after reading the speed measured by the speedometer, the movable platform may use the above-mentioned communication connection with the mobile terminal to send the speed measured by the speedometer to the mobile terminal, such that the mobile terminal is able to obtain the speed of the movable platform.

At S103, second positioning information is obtained.

That the second positioning information may also be the positioning information obtained by a positioning assembly provided at the mobile terminal and/or the movable platform through receiving the satellite positioning signal (such as the GNSS signal or the GPS signal).

In various embodiments, the positioning assembly for obtaining the second positioning information may be the same as or different from the positioning assembly for obtaining the first positioning information.

At S104, the first movement trajectory is corrected according to the second positioning information.

Since the second positioning information is also obtained by the positioning assembly receiving the satellite positioning signal, the second positioning information may be also relatively accurate positioning information, and the first movement trajectory may be corrected using the accurate second positioning information to ensure the accuracy of the corrected first movement trajectory.

The second positioning information may also include multiple pieces of position information. Second position information of the movable platform may be determined based on the multiple pieces of position information, and the first movement trajectory may be corrected using the second position information.

In one embodiment, the second position information may be the first position information of the multiple positions determined through the second positioning information. The correction of the first movement trajectory may include directly determining the first position information of the multiple positions as the end point of the first movement trajectory.

In some other embodiments, the second position information may include one of a preset number of positions closest to the first position information among the multiple positions determined through the second positioning information. For example, assuming that the second positioning information includes 6 positions, namely A, B, C, D, E, and F, and the preset number is 2, among the above 6 positions, the 2 positions closest to the first position information may be B and C, and then the position B or position C may be determined as the end point of the first movement trajectory.

In some other embodiments, the second position information may include multiple positions determined through the second positioning information. Correspondingly, the correction process of the first movement trajectory may also include: generating a third movement trajectory of the movable platform using the multiple positions, and determining the starting point of the third movement trajectory as the end point of the first movement trajectory.

In various embodiments, the first positioning information and the second positioning information may be positioning information respectively obtained by the positioning assembly at two different moments.

The first positioning information may be obtained at a first moment, and the second positioning information may be obtained at a second moment, where a preset time interval exists between the first moment and the second moment. That is, the attitude information of the movable platform may be obtained within the preset time interval.

In some embodiments, the first positioning information may be the positioning information collected before the positioning assembly detects that it cannot receive the satellite positioning signal, and the second positioning information may be the positioning information collected when the positioning assembly detects that it is able to re-obtain the satellite positioning signal.

As an example and not a limitation, assuming that the movable platform is a bicycle, the mobile terminal is a bike computer, and a positioning assembly is provided at the bike computer, when the user passes through a long tunnel during riding and the positioning assembly provided at the bike computer cannot receive the satellite positioning signal in the tunnel, the first positioning information may be the positioning information determined before entering the tunnel according to the satellite positioning signal received by the positioning assembly of the bike computer; and the second positioning information may be the positioning information determined after the user passes through the tunnel and the positioning assembly of the bike computer can re-receive the satellite positioning signal.

In the above possible embodiments, when the mobile terminal and/or the movable platform cannot receive the satellite positioning signal or the satellite positioning signal is poor, the first positioning information obtained at the first moment and the attitude information of the movable platform (or the mobile terminal) may be used to generate the first movement trajectory. Then, the first movement trajectory may be corrected using the second positioning information obtained at the second moment, to obtain the corrected first movement trajectory. Since the first positioning information and the second positioning information are both determined by the positioning assembly collecting the satellite positioning signal, the accuracy of the initial position and the end position of the first movement trajectory may be effectively guaranteed, and the occurrence of the inaccurate first movement trajectory caused by the inaccuracy of the initial position or the end position may be avoided. Therefore, compared with cases only using the accuracy of the end position to correct the movement trajectory of the movable platform, the above embodiments may further improve the accuracy of the first movement trajectory from the perspective of effectively ensuring that the initial position and the end position of the first movement trajectory are both accurate, and effectively solve the problem that the movement trajectory generated by the existing electronic device is not accurate.

In some other embodiments, the mobile terminal and/or the movable platform may generate a first instruction corresponding to a first operation in response to the first operation, where the first operation is used to reduce the sampling frequency of the positioning assembly receiving the satellite positioning signal. The mobile terminal and/or the movable platform may respond to the above-mentioned first instruction to reduce the sampling frequency of the positioning assembly receiving the satellite positioning signal from the first sampling frequency to the second sampling frequency. The sampling period in the second sampling frequency may correspond a preset duration of the interval between the time of obtaining the first positioning information and the time of obtaining the second positioning information. That is, the sampling period in the second sampling frequency may be equal to the preset duration.

For example, the sampling frequency of the positioning assembly receiving the satellite positioning signal is usually once per second, that is, the first sampling frequency is once per second. After the mobile terminal and/or the movable platform responds to the first operation, the sampling frequency of the positioning assembly receiving the satellite positioning signal may be reduced to once every 45 seconds, that is, the second sampling frequency is once every 45 seconds. In this case, the sampling period of the second sampling frequency may be 45 seconds. That is, the preset duration of the interval between the time of obtaining the first positioning information and the time of obtaining the second positioning information may be 45 seconds. Assuming that the first positioning information is obtained at the first moment, the second moment for obtaining the second positioning information may be equal to the first moment plus 45 seconds.

In one embodiment, the first operation may be a selection operation of the user triggering the “power saving mode” on the mobile terminal (or the mobile platform); or a series of operations before the selection operation of the user triggering the “power saving mode” on the mobile terminal (or the mobile platform).

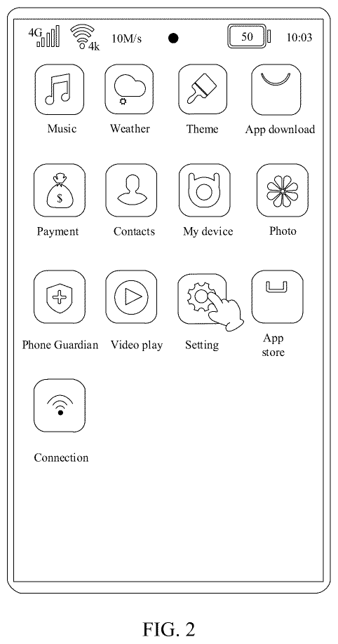

For example, in one embodiment, the mobile terminal may be a mobile phone. As shown in FIG. 2, on the desktop of the mobile phone, application icons corresponding to multiple applications are displayed. The application icons corresponding to the multiple applications may include but are not limited to, an application icon of music application, an application icon of weather application, an application icon of theme application, an application icon of download application, an application icon of payment application, an application icon of settings application, etc. The present disclosure does not limit the specific content of the application icons of applications displayed on the desktop of the mobile phone.

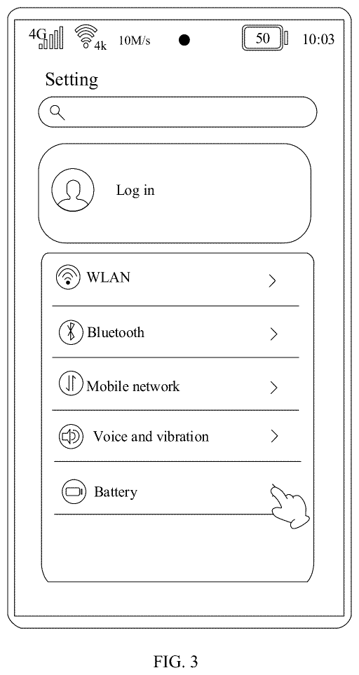

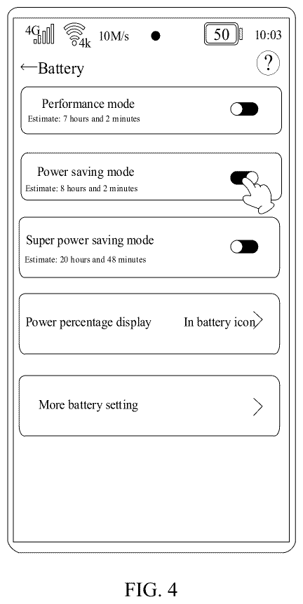

As shown in FIG. 2, after the user triggers the application icon of the setting application and starts the settings application, the interface content shown in FIG. 3 may be displayed. The interface content may display five setting selection objects of wireless local area networks (WLAN), Bluetooth, mobile network, sound and vibration, and battery. After the user triggers the battery setting selection object, the interface shown in FIG. 4 may be displayed. The interface may display multiple selection controls, such as performance mode, power saving mode, super power saving, power percentage display mode, and more battery settings. In response to the user's selection operation of the power saving mode, the positioning assembly may reduce the sampling frequency of receiving the satellite positioning signal.

In another embodiment, the first operation may also be an operation of automatically triggering the reduction of the sampling frequency of the positioning assembly when the power of the mobile terminal (or the movable platform) is lower than a preset threshold. For example, assuming that the mobile terminal is still a mobile phone and the preset threshold is 20% of the total power of the mobile phone, when the power of the mobile phone is lower than 20% of the total power, the positioning assembly may automatically reduce the sampling frequency of receiving satellite positioning signals.

In another embodiment, the first operation may also be that: when the power of the mobile terminal (or the movable platform) is lower than the preset threshold, after the low power prompt message is displayed on the display screen of the mobile terminal (or movable platform), the user triggers the selection operation of the power saving mode.

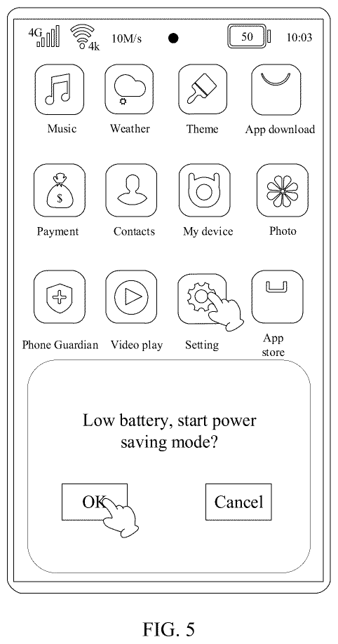

For example, as shown in FIG. 5, assuming that the mobile terminal is still a mobile phone and the preset threshold is 30% of the total power of the mobile phone, when the power of the mobile phone is lower than 30% of the total power, the option box of “low power, whether to turn on the power saving mode” may be displayed on the display screen of the mobile phone. When the user clicks the “OK” control, the positioning assembly may respond to the user's clicking operation on the “OK” control and reduce the sampling frequency of receiving the satellite positioning signals.

In some other embodiments, the first operation may also be the user's operation that directly triggering a physical button corresponding to the reduction of the sampling frequency of the positioning assembly provided at the mobile terminal (or the movable platform). The specific content of the first operation is not limited by the present disclosure.

In one embodiment, the preset duration between the time of obtaining the first positioning information and the time of obtaining the second positioning information may be longer than or equal to 30 seconds, and shorter than or equal to 120 seconds, that is, 30 s≤T≤120 s, where T represents the above preset duration.

In some embodiments, the preset duration may be 30 s, 60 s or 120 s. According to actual experimental tests, when the interval between the obtaining time of the first positioning information and the obtaining time of the second positioning information is 30 s, the positioning assembly may receive the satellite positioning signal once every 30 s, and the power consumed by the positioning assembly receiving the satellite positioning signals in the mobile terminal and/or the movable platform may be still large although the error of the first movement trajectory formed is small, because of the short interval time.

When the interval between the obtaining time of the first positioning information and the obtaining time of the second positioning information is 120 s, although the power consumed by the positioning assembly receiving the satellite positioning signal in the mobile terminal and/or the movable platform may be significantly reduced, the time interval between the positioning assembly receiving the satellite positioning signal may be slightly longer, resulting in a lower accuracy of the generated first movement trajectory, and the actual measurement of the error of the first movement trajectory may be about 10 meters.

When the time interval between the obtaining time of the first positioning information and the obtaining time of the second positioning information is increased further, the error of the generated first movement trajectory may become larger and larger. For example, when the time interval between the obtaining time of the first positioning information and the obtaining time of the second positioning information is 300 seconds, the error of the generated movement trajectory may be about 15 meters.

Taking into account the accuracy of the first movement trajectory and the power consumption of the mobile terminal and/or the movable platform, in actual applications, the time interval between the obtaining time of the first positioning information and the obtaining time of the second positioning information may be set to 60 seconds.

In the present disclosure, after the first operation is executed, under the condition of reducing the sampling frequency of the positioning assembly receiving the satellite positioning signal, the first positioning information obtained at the first moment and the attitude information of the movable platform (or the mobile terminal) may be used to generate the first movement trajectory. The attitude information of the movable platform (or the mobile terminal) may be obtained between the first moment and the second moment. Then the first movement trajectory may be corrected using the second positioning information obtained at the second moment, and the corrected first movement trajectory may be obtained. Since the first positioning information and the second positioning information are both determined by the positioning assembly collecting the satellite positioning signal, the accuracy of the initial position and the end position of the first movement trajectory may be effectively guaranteed, and the accuracy of the corrected first movement trajectory may be guaranteed. Further, by reasonably extending the time interval between the obtaining time of the first positioning information and the obtaining time of the second positioning information, the power consumption of the mobile terminal and/or the movable platform may be effectively reduced, the battery life of the mobile terminal and/or the movable platform may be extended, and the user experience may be improved.

In some embodiments, the disclosed devices/electronic devices and methods can be implemented in other ways. For example, the device/electronic device embodiments described above are merely schematic. For example, the division of modules or units is only a logical function division. There may be other division methods in actual implementation, such as multiple units or components can be combined or integrated into another system, or some features can be ignored or not executed. The specific content of each unit implementation can refer to the specific description in the above-mentioned other embodiments, and will not be repeated here.

The units described above as separate components may or may not be physically separated, and the components displayed as units may or may not be physical units, that is, they may be located in one place, or they may be distributed on multiple network units. Some or all of the units may be selected according to actual needs to achieve the purpose of the scheme of this embodiment.

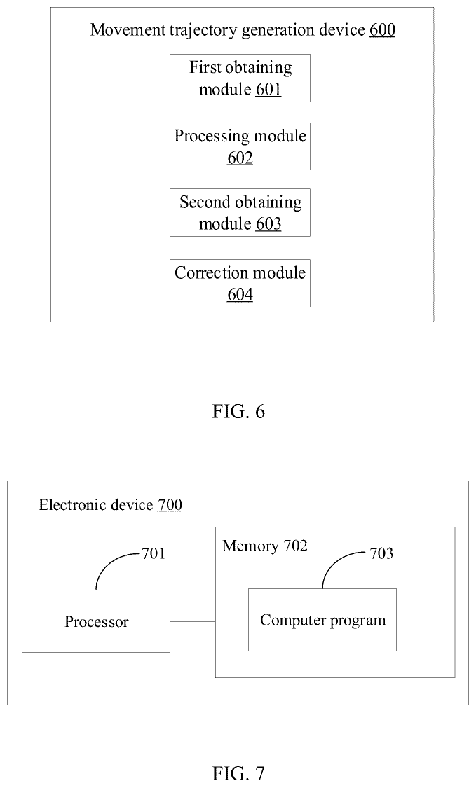

The present disclosure also provides a movement trajectory generation device. In one embodiment, as shown in FIG. 6, the movement trajectory generation device 600 may include:
a first obtaining module 601, used to obtain first positioning information and to obtain attitude information of a movable platform;
a processing module 602, used to generate a first movement trajectory of the movable platform according to the first positioning information and the attitude information of the movable platform;
a second obtaining module 603, used to obtain second positioning information; and
a correction module 604, used to correct the first movement trajectory according to the second positioning information.

In some embodiments, the movement trajectory generation device 600 may further include: a first determination module used to determine a first position information of the movable platform according to the first positioning information. The processing module 602 may be further used to generate the first movement trajectory according to the first position information and the attitude information of the movable platform.

In some embodiments, the first position information may include a starting point of the first movement trajectory. The processing module 602 may be further used to generate the first movement trajectory according to the starting point of the first movement trajectory and the attitude information of the movable platform.

In some embodiments, the attitude information of the movable platform may be obtained when it is detected that the satellite positioning signal cannot be obtained.

In some embodiments, the movement trajectory generation device 600 may further include a first generation module used to generate a second movement trajectory of the movable platform according to the first position information. The processing module 602 may be further used to determine the end point of the second movement trajectory as the starting point of the first movement trajectory.

In some embodiments, the first positioning information may be obtained at a first moment, and the second positioning information may be obtained at a second moment. The first moment and the second moment may be separated by a preset time duration.

In some embodiments, the preset time duration may be longer than or equal to 30 seconds, and shorter than or equal to 120 seconds.

In some embodiments, the preset time duration may be 30 seconds, 60 seconds or 120 seconds.

In some embodiments, the attitude information of the movable platform may be obtained within the preset time duration.

In some embodiments, the movement trajectory generation device 600 may further include: a second determination module used to determine a second position information of the movable platform according to the second positioning information. The correction module 504 may be further used to: correct the first movement trajectory according to the second position information.

In some embodiments, the correction module 604 may be further used to: determine the second position information as the end point of the first movement trajectory.

In some embodiments, the second positioning information may be obtained when it is detected that the satellite positioning signal can be re-obtained.

In some embodiments, the movement trajectory generation device 600 may further include: a second generating module used to generate a third movement trajectory of the movable platform according to the second position information. The correction module 604 may be further used to: determine the starting point of the third movement trajectory as the end point of the first movement trajectory.

In some embodiments, the attitude information may include a direction of the movable platform. The processing module 602 may be further used to: generate the first movement trajectory according to the first positioning information and the direction of the movable platform.

In some embodiments, the first obtaining module 601 may be further used to obtain a speed of the movable platform. The processing module 602 may be further used to: generate the first movement trajectory according to the first positioning information, the speed of the movable platform and the direction of the movable platform.

In some embodiments, the speed of the movable platform may be obtained by a speedometer fixed at the movable platform.

In some embodiments, the speedometer may be provided at the mobile terminal.

In some embodiments, the speedometer may be provided at the movable platform, and the speedometer may be communicatively connected to the mobile terminal.

The present disclosure also provides an electronic device. As shown in FIG. 7, in one embodiment, the electronic device 700 includes at least one processor 701, at least one memory 702, and at least one computer program 703 stored in the at least one memory 710 and able to be executed on the at least one processor 701. When the at least one processor 701 executes the at least one computer program 703, the at least one processor 701 may be configured to: obtain first positioning information and attitude information of a movable platform; generate a first movement trajectory of the movable platform according to the first positioning information and the attitude information of the movable platform; obtain second positioning information; and correct the first movement trajectory according to the second positioning information.

In some embodiments, the at least one processor 701 may be further configured to: determine a first position information of the movable platform according to the first positioning information. Generating the first movement trajectory of the movable platform according to the first positioning information and the attitude information of the movable platform may include: generating the first movement trajectory according to the first position information and the attitude information of the movable platform.

In some embodiments, the first position information may include a starting point of the first movement trajectory. When generating the first movement trajectory according to the first position information and the attitude information of the movable platform, the at least one processor 701 may be further configured to: generate the first movement trajectory according to the starting point of the first movement trajectory and the attitude information of the movable platform.

In some embodiments, the attitude information of the movable platform may be obtained when it is detected that the satellite positioning signal cannot be obtained.

In some embodiments, the at least one processor 701 may be further configured to: generate a second movement trajectory of the movable platform according to the first position information. When generating the first movement trajectory according to the first position information and the attitude information of the movable platform, the at least one processor 701 may be further configured to: determine the end point of the second movement trajectory as the starting point of the first movement trajectory.

In some embodiments, the first positioning information may be obtained at a first moment, and the second positioning information may be obtained at a second moment. The first moment and the second moment may be separated by a preset time duration.

In some embodiments, the preset time duration may be longer than or equal to 30 seconds, and shorter than or equal to 120 seconds.

In some embodiments, the preset time duration may be 30 seconds, 60 seconds or 120 seconds.

In some embodiments, when generating the first movement trajectory according to the first position information and the attitude information of the movable platform, the attitude information of the movable platform may be obtained within the preset time duration.

In some embodiments, the at least one processor 701 may be further configured to: determine a second position information of the movable platform according to the second positioning information. When correcting the first movement trajectory according to the second positioning information, the at least one processor 701 may be further configured to correct the first movement trajectory according to the second position information.

In some embodiments, correcting the first movement trajectory according to the second position information may include determining the second position information as the end point of the first movement trajectory.

In some embodiments, the second positioning information may be obtained when it is detected that the satellite positioning signal can be re-obtained.

In some embodiments, the at least one processor 701 may be further configured to generate a third movement trajectory of the movable platform according to the second position information. When correcting the first movement trajectory according to the second position information, the at least one processor 701 may be further configured to: determine the starting point of the third movement trajectory as the end point of the first movement trajectory.

In some embodiments, the attitude information may include a direction of the movable platform. When generating the first movement trajectory according to the first position information and the attitude information of the movable platform, the at least one processor 701 may be further configured to: generate the first movement trajectory according to the first positioning information and the direction of the movable platform.

In some embodiments, the at least one processor 701 may be further configured to obtain a speed of the movable platform. When generating the first movement trajectory according to the first position information and the attitude information of the movable platform, the at least one processor 701 may be further configured to: generate the first movement trajectory according to the first positioning information, the speed of the movable platform and the direction of the movable platform.

In some embodiments, the speed of the movable platform may be obtained by a speedometer fixed at the movable platform.

In some embodiments, the speedometer may be provided at the mobile terminal.

In some embodiments, the speedometer may be provided at the movable platform, and the speedometer may be communicatively connected to the mobile terminal.

The at least one computer program 703 may be divided into one or more modules/units, and the one or more modules/units may be stored in the at least one memory 702 and executed by the at least one processor 701 to implement the movement trajectory generation method provided by various embodiments of the present disclosure. The one or more modules/units may be a series of computer program instruction segments capable of completing specific functions, and the instruction segments may be used to describe the execution process of the at least one computer program in the electronic device 700.

The embodiment shown in FIG. 7 is only used as an example to illustrate the present disclosure, and does not limit the scope of the present disclosure. The electronic device may include more or fewer components than shown in the figure, or combine certain components, or different components, such as input and output devices, network access devices, etc. The input and output devices may include cameras, audio obtaining/playback devices, display screens, etc. The network access devices may include a network module for wireless network communication with external devices.

In various embodiments, the processor may be a central processing unit (CPU), and may also be other general-purpose processors, digital signal processors (DSP), application-specific integrated circuits (ASIC), field-programmable gate arrays (FPGA) or other programmable logic devices, discrete gates or transistor logic devices, discrete hardware components, etc. The general-purpose processor may be a microprocessor or any conventional processor, etc.

In some embodiments, the at least one memory may be an internal storage unit of the electronic device, such as a hard disk or memory of the terminal device. In some other embodiments, the at least one memory may also be an external storage device of the electronic device, for example, a plug-in hard disk, a smart media card (SMC), a secure digital (SD) card, a flash card, etc. equipped on the terminal device. The at least one memory may also include both an internal storage unit of the electronic device and an external storage device. The at least one memory may be used to store an operating system, an application program, a boot loader, data, or other programs, such as program codes of a computer program. The at least one memory may also be used to temporarily store data that has been output or is to be output.

The present disclosure also provides a computer readable storage medium. The computer readable storage medium may be configured to store a computer program. When the at least one computer program is executed by a processor, the movement trajectory generation method provided by various embodiments of the present disclosure may be implemented.

When an integrated unit is implemented in the form of a software functional unit and sold or used as an independent product, it may be stored in a computer-readable storage medium. Based on this understanding, all or part of the processes in the above method embodiments of the present disclosure may be implemented by instructing the relevant hardware through a computer program. The at least one computer program may be stored in a computer-readable storage medium. When the at least one computer program is executed by the processor, the steps of the above method embodiments may be implemented. The at least one computer program may include computer program code which may be in source code form, object code form, executable file or some intermediate form. The computer-readable medium may at least include: any entity or device that can carry the at least one computer program code to the camera/electronic device, recording medium, computer memory, ROM (read-only memory), RAM (random access memory), CD-ROM (compact disc read-only memory), magnetic tape, floppy disk and optical data storage device. The computer-readable storage medium mentioned in the present disclosure may be a non-volatile storage medium, in other words, a non-transient storage medium.

All or part of the processes in the methods provided by various embodiments of the present disclosure may be implemented by instructing the relevant hardware through a computer program. The at least one computer program may be stored in a computer-readable storage medium. When the at least one computer program is executed by a processor, the steps of each of the above-mentioned method embodiments may be implemented. The at least one computer program may include computer program codes, and the at least one computer program codes may be in a source code form, an object code form, an executable file or some intermediate forms. The computer-readable medium may at least include: any entity or device that is able to carry the at least one computer program codes to the terminal device, a recording medium, a computer memory, a read-only memory (ROM), a random access memory (RAM), an electrical carrier signal, a telecommunication signal, or a software distribution medium such as, for example, a USB flash drive, a mobile hard disk, a disk or an optical disk.

Each embodiment in this specification is described in a progressive mode, and each embodiment focuses on the difference from other embodiments. Same and similar parts of each embodiment may be referred to each other. As for the device disclosed in the embodiments, since it corresponds to the method disclosed in the embodiments, the description is relatively simple, and for relevant details, the reference may be made to the description of the method embodiments.

Devices and algorithm steps of the examples described in conjunction with the embodiments disclosed herein may be implemented by electronic hardware, computer software or a combination of the two. To clearly illustrate the possible interchangeability between the hardware and software, in the above description, the composition and steps of each example have been generally described according to their functions. Whether these functions are executed by hardware or software depends on the specific application and design constraints of the technical solution. Those skilled in the art may use different methods to implement the described functions for each specific application, but such implementation should not be regarded as exceeding the scope of the present disclosure.

In the present disclosure, the drawings and descriptions of the embodiments are illustrative and not restrictive. The same drawing reference numerals identify the same structures throughout the description of the embodiments. In addition, figures may exaggerate the thickness of some layers, films, screens, areas, etc., for purposes of understanding and ease of description. It will also be understood that when an element such as a layer, film, region or substrate is referred to as being “on” another element, it may be directly on the another element or intervening elements may be present. In addition, “on” refers to positioning an element on or below another element, but does not essentially mean positioning on the upper side of another element according to the direction of gravity.

The orientation or positional relationship indicated by the terms “upper,” “lower,” “top,” “bottom,” “inner,” “outer,” etc. are based on the orientation or positional relationship shown in the drawings, and are only for the convenience of describing the present disclosure, rather than indicating or implying that the device or element referred to must have a specific orientation, be constructed and operated in a specific orientation, and therefore cannot be construed as a limitation of the present disclosure. When a component is said to be “connected” to another component, it may be directly connected to the other component or there may be an intermediate component present at the same time.

It should also be noted that in this article, relational terms such as “first” and “second” are only used to distinguish one entity or operation from another entity or operation, and do not necessarily require or imply that there is such actual relationship or sequence between these entities or operations them. Furthermore, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element defined by the statement “comprises a . . . ” does not exclude the presence of other identical elements in an article or device that includes the above-mentioned element.

The disclosed equipment and methods may be implemented in other ways. The device embodiments described above are only illustrative. For example, the division of the units is only a logical function division. In actual implementation, there may be other division methods, such as: multiple units or components may be combined, or can be integrated into another system, or some features can be ignored, or not implemented. In addition, the coupling, direct coupling, or communication connection between the components shown or discussed may be through some interfaces, and the indirect coupling or communication connection of the devices or units may be electrical, mechanical, or other forms.

The units described above as separate components may or may not be physically separated. The components shown as units may or may not be physical units. They may be located in one place or distributed to multiple network units. Some or all of the units may be selected according to actual needs to achieve the purpose of the solution of the present disclosure.

In addition, all functional units in the embodiments of the present disclosure may be integrated into one processing unit, or each unit may be separately used as a unit, or two or more units can be integrated into one unit. The above-mentioned integration units can be implemented in the form of hardware or in the form of hardware plus software functional units.

Various embodiments have been described to illustrate the operation principles and example implementations. The present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A movement trajectory generation method comprising:
obtaining first positioning information;
obtaining attitude information of a movable platform;
generating a movement trajectory of the movable platform according to the first positioning information and the attitude information of the movable platform;
obtaining second positioning information; and
correcting the movement trajectory according to the second positioning information.

2. The method according to claim 1, wherein obtaining the attitude information of the movable platform includes obtaining the attitude information of the movable platform in response to inability to obtain a satellite positioning signal.

3. The method according to claim 1, further comprising:
determining position information of the movable platform according to the first positioning information;
wherein generating the movement trajectory of the movable platform includes generating the movement trajectory according to the position information and the attitude information of the movable platform.

4. The method according to claim 3, wherein:
the position information includes a starting point of the movement trajectory; and
generating the movement trajectory according to the position information and the attitude information of the movable platform includes generating the movement trajectory according to the starting point and the attitude information of the movable platform.

5. The method according to claim 3,
wherein the movement trajectory is a first movement trajectory of the movable platform;
the method further comprising:
generating a second movement trajectory of the movable platform according to the position information,
wherein generating the first movement trajectory according to the position information and the attitude information of the movable platform includes determining an end point of the second movement trajectory as a starting point of the first movement trajectory.

6. The method according to claim 1, wherein:
obtaining the first positioning information includes obtaining the first positioning information at a first moment;
obtaining the second positioning information includes obtaining the second positioning information at a second moment; and
the first moment and the second moment are separated by a preset time duration.

7. The method according to claim 6, wherein the preset time duration is longer than or equal to 30 seconds, and shorter than or equal to 120 seconds.

8. The method according to claim 6, wherein obtaining the attitude information of the movable platform includes obtaining the attitude information of the movable platform within the preset time duration.

9. The method according to claim 1, further comprising:
determining position information of the movable platform according to the second positioning information;
wherein correcting the movement trajectory according to the second positioning information includes correcting the movement trajectory according to the position information.

10. The method according to claim 9, wherein correcting the movement trajectory according to the position information includes determining the position information as an end point of the movement trajectory.

11. The method according to claim 9,
wherein the movement trajectory is a first movement trajectory of the movable platform;
the method further comprising:
generating a second movement trajectory of the movable platform according to the position information;
wherein correcting the first movement trajectory according to the position information includes determining a starting point of the second movement trajectory as an end point of the first movement trajectory.

12. The method according to claim 1, wherein obtaining the second positioning information includes obtaining the second positioning information in response to re-obtaining a satellite positioning signal after the satellite positioning signal is lost.

13. The method according to claim 1, wherein:
the attitude information includes a direction of the movable platform; and
generating the movement trajectory of the movable platform according to the first positioning information and the attitude information of the movable platform includes generating the movement trajectory according to the first positioning information and the direction of the movable platform.

14. The method according to claim 13, further comprising:
obtaining a speed of the movable platform;
wherein generating the movement trajectory according to the first positioning information and the direction of the movable platform includes generating the movement trajectory according to the first positioning information, the speed of the movable platform, and the direction of the movable platform.

15. The method according to claim 14, wherein obtaining the speed of the movable platform includes obtaining the speed of the movable platform through a speedometer fixed at the movable platform.

16. An electronic device comprising:
at least one memory storing at least one computer program; and
at least one processor configured to execute the at least one computer program to:
obtain first positioning information;
obtain attitude information of a movable platform;
generate a movement trajectory of the movable platform according to the first positioning information and the attitude information of the movable platform;
obtain second positioning information; and
correct the movement trajectory according to the second positioning information.

17. The electronic device according to claim 16, wherein the at least one processor is configured to execute the at least one computer program to obtain the attitude information of the movable platform in response to inability to obtain a satellite positioning signal.

18. The electronic device according to claim 16, wherein the at least one processor is configured to execute the at least one computer program to:
determine position information of the movable platform according to the first positioning information; and
when generating the movement trajectory of the movable platform, generate the movement trajectory according to the position information and the attitude information of the movable platform.

19. The electronic device according to claim 18, wherein:
the position information includes a starting point of the movement trajectory; and
the at least one processor is configured to execute the at least one computer program to, when generating the movement trajectory according to the position information and the attitude information of the movable platform, generate the movement trajectory according to the starting point and the attitude information of the movable platform.

20. A non-transitory computer-readable storage medium store at least one computer program that, when executed by at least one processor, causes the at least one processor to:
obtain first positioning information;
obtain attitude information of a movable platform;
generate a movement trajectory of the movable platform according to the first positioning information and the attitude information of the movable platform;
obtain second positioning information; and
correct the movement trajectory according to the second positioning information.
